(19) United States
(12) Patent Application Publication
(10) Pub. No.: US 2010/0255200 A1
(43) Pub. Date: Oct. 7, 2010

(54) Method for the production of turbine components

(76) Inventors: Bulent Kaya, Berlin (DE); Francis-Jurjen Ladru, Berlin (DE); Marcus Mensing, Berlin (DE); Mahinda Wanigasinghe, Middleton, NY (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/653,721

(22) Filed: Jan. 12, 2007

(30) Foreign Application Priority Data
Jan. 17, 2006 (EP) 06000916.4

(51) Int. Cl. B05D 1/32

(52) U.S. Cl. 427/282

(57) ABSTRACT

The invention relates to a method for production of turbine components having at least one flow body, which has cooling air outlet openings arranged in the area of its trailing edge with the flow body, for example a blade section, being provided with an in particular ceramic coating by spraying coating. According to the invention, before the coating is applied, the cooling air outlet openings are completely covered by a covering strip which is composed of a material which is resistant to the coating process.

### CROSS REFERENCE TO RELATED APPLICATIONS

This application claims priority of European application No. 06000916.4 EP filed Jan. 17, 2006, which is incorporated by reference herein in its entirety.

### FIELD OF INVENTION

The invention relates to a method for production of turbine components having at least one flow body for example a blade section, which has a row of cooling air outlet openings arranged alongside one another in the area of its trailing edge with the flow body, wherein the flow body is provided with an in particular ceramic coating by a spray coating process.

### BACKGROUND OF THE INVENTION

Gas turbines in particular use turbine components which have one or more flow bodies which are subjected to the gas flow. Flow bodies such as these are, in particular, the blade sections of turbine blades, which can be in the form of rotor blades or stator blades. In the case of a ringed segment, the turbine component has a plurality of stator blades that are separated from one another.

If the gas turbine is operated at high temperatures, the turbine blades are air-cooled. For this purpose, cooling air is introduced into their cavities via a blade root of the turbine blades. The cooling air then emerges via cooling air outlet openings. A large number of such cooling air outlet openings are located on the pressure side of the blade section, immediately adjacent to its trailing edge, where they are arranged in a row alongside one another.

Examples of turbine blades such as these can be found in EP 1 015 736 B1, EP 1 471 210, DE 692 10 892 T1, DE 36 42 789 A1 and DE 69420 582 T2. The cooling air outlet openings there are used to cool the trailing edge, which runs to a point.

In order to improve the temperature resistance and/or abrasion resistance, the blade sections are additionally provided with a coating composed of suitable metals, metal alloys or ceramics. In order to avoid impeding the heat transfer from the blade sections of the cooling air in the area of the cooling air outlet openings on the trailing edge side, it is necessary for the cooling air outlet openings there to be kept free of coating material during the coating process. If the coating process is carried out by means of EB-PVD (electrobeam physical vapor deposition), this can be done by appropriate control of the apparatus without any special further measures. However, this is not possible when the coating is applied by means of a spray coating process. Examples of spray coating processes are atmospheric plasma spraying (APS) and high-velocity flame spraying (HVOF) (see Ullman's Encyclopedia of Industrial Chemistry, 2003, volume 21, pages 573 and 575).

### SUMMARY OF INVENTION

The invention is thus based on the object of providing a method for production of, in particular, turbine blades with cooling air outlet openings in the area of the trailing edge, which on the one hand avoids coating of the cooling air outlet openings, but on the other hand allows coating to a point close to the cooling air outlet openings.

According to the invention, this object is achieved in that the cooling air outlet openings are covered by a covering strip before the application of the coating, which covering strip is composed of a material which is resistant to the spray coating. Metals, in particular steel, are suitable for use as the material for the covering strip.

The fundamental idea of the invention is to protect the cooling air outlet openings on the trailing edge side during the application of the coating by fitting a covering strip to protect against ingress of coating material. In this case, the covering strip can be matched to the respective flow body such that the covering of the flow body beyond the cooling air outlet opening can be kept to a minimum, that is to say it can be limited to 2 to 3 mm. This results in the flow body being very largely protected by the coating without any risk of the coating material significantly entering the cooling air outlet openings, and being deposited there.

One embodiment of the invention provides .a covering strip to be used which has projections which fit into the cooling air outlet openings, and for the covering strip to be plugged onto the flow body with the projections being inserted into the cooling air outlet openings. In this case, it should be possible to bend the projections plastically by hand in order that the projections can be matched to the respective shape of the cooling air outlet openings and of the adjacent cooling air channels. In addition, the covering strip should itself have sufficiently thin walls that it can be matched to the shape of the flow body in the area of the trailing edge by bending or else by cutting.

The method according to the invention can be developed by application of a gas, in particular compressed air, to the flow body during the spray coating process, in such a manner that the gas flows out of the cooling air outlet openings. This prevents coating material from entering any gaps that may be present between the surface of the flow body and the covering strip, and being precipitated in the cooling air outlet openings.

A similar effect can be achieved by completely covering the cooling air outlet openings with an adhesive tape before the application of the covering strip. In order that the adhesive tape is protected against the influence of heat resulting from the spray coating process, a covering strip should be used which completely covers the adhesive tape after the covering strip has been fitted. The projections on the covering strip should be designed such that they pierce the adhesive tape when plugged on. This can be made easier by providing incisions in the adhesive tape at the points at which it is intended to be pierced by the projections.

If any coating material—also referred to as “overspray” penetrates into the cooling air openings despite the provision of the covering strip, possibly in conjunction with an adhesive tape, the coating material can be removed from the cooling air outlet openings by means of fine sand blasting (“pencil blasting”). In order to prevent damage to the coating outside the cooling air outlet openings, the coating should be covered by means of an adhesive tape, for example, during this process in an area adjacent to the cooling air outlet openings.

### BRIEF DESCRIPTION OF THE DRAWINGS

The invention is illustrated in more detail in the drawing using one exemplary embodiment.

In the drawings:

FIG. 1 shows a perspective view of a rotor blade for a continuous-flow machine, with a covering strip, and

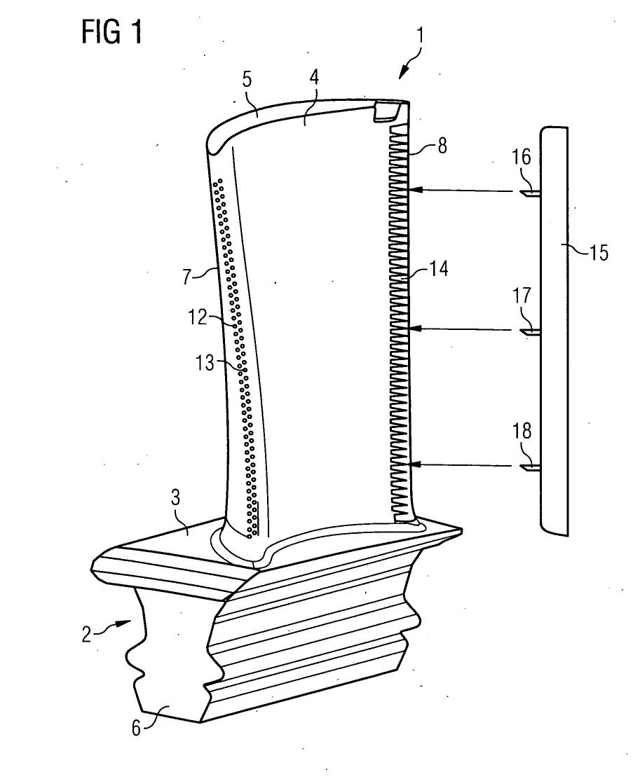

FIG. 2 shows a cross section through the rotor blade shown in FIG. 1, with a covering strip.

### DETAILED DESCRIPTION OF INVENTION

The rotor blade 1 illustrated in the figures is intended for a continuous-flow machine, which may be a gas turbine for an aircraft or a power station for electricity generation, or else a steam turbine or a compressor. The rotor blade 1 has, successively, an attachment area 2, a blade platform 3 adjacent to it, a blade section 4 and a blade tip 5. A blade root 6 is formed in the attachment area 2 and is used for attachment of the rotor blade 1 to a shaft or to a disk (not illustrated). The blade root 6 is in the form of a firtree root but may, for example, also be in the form of a hammerhead or a dovetail root. The rotor blade 1 has a leading edge 7 and a trailing edge 8 for a medium which flows over the blade section 4.

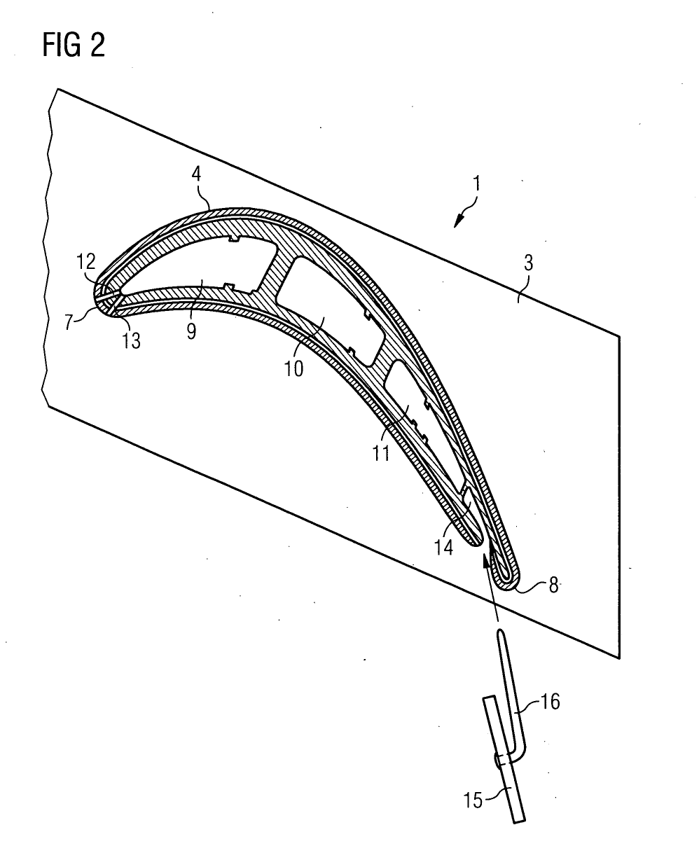

As can be seen in particular from FIG. 2, the blade section 4 is hollow, in which case the cavities 9, 10, 11 formed in this way can have cooling air applied to them via the blade root 6. The cooling air emerges at the leading edge 7 via a large number of cooling air outlet openings 12, 13 which are arranged in pairs, in order to produce an air layer, which acts as an insulating layer, in this area. A large number of cooling air outlet openings—annotated with 14 by way of example—are also provided in the area of the trailing edge 8, are arranged on the pressure side of the blade section 4 and are designed such that the cooling air which emerges there emerges tangentially to the direction of the trailing edge 8, so that the cooling air outlet openings 14 are in the form of pockets.

A massive metallic material, in particular a superalloy, is used for all of the parts of the rotor blade 1. Superalloys such as these are disclosed, for example, in EP 1 204 776 B1, EP 1 306 454, EP 1 319 729 A1, WO 99/67435 or WO 00/44949. In this case, the rotor blade 1 can be manufactured by means of a casting process or else by means of directed solidification by means of a forging process, by means of a milling process or a combination thereof. The rotor blade 1 is intended to be provided with a coating of the blade section 4, which coating may also be in the form of more than one layer. A coating against corrosion or oxidation may be composed on the basis of the formula MCrAlX, where M is at least one element from the group comprising iron (Fe), cobalt (Co) and nickel (Ni) and X is an active element, and represents yttrium (Y) and/or silicon and/or at least one element from the rare earths or hafnium (Hf). Alloys such as these are disclosed in EP 0 486 489 B1, EP 0 786, 017 B1, EP 0 412 397 B1 or EP 1 306 454 A1 which are intended to form part of this disclosure with regard to the chemical composition of the alloy.

A heat insulating layer can also be provided on the MCrAlX layer and is composed, for example, of ZrO₂, Y₂O₃—ZrO₂, that is to say it is not partially or completely stabilized by yttrium oxide and/or calcium oxide and/or magnesium oxide. In the method according to the invention, the heat insulating layer is applied by atmospheric plasma spraying (APS) or by high-velocity flame spraying (HVOF).

In order to avoid adversely affecting the effectiveness of the cooling air outlet from the cooling air outlet openings 14 on the trailing edge side, it is necessary to avoid coating material from entering the cooling air outlet openings 14 during the spray coating process by means of the abovementioned process. For this purpose, a covering strip 15 is provided, composed of a metal sheet, which is designed to be sufficiently long that it extends over all of the cooling air outlet openings 14. Its width is of such a size that it completely covers the cooling air outlet openings 14, with the covering strip 15 being 2 to 3 mm broader on both longitudinal sides in order to reliably prevent ingress of coating material, or on the other hand, however, the coating should be allowed to extend to a point close to the cooling air outlet openings 14.

On one side, the covering strip 15 has holding pins 16, 17, 18 which are of such a size and are separated by such a distance that they can each be inserted into one cooling air outlet opening 14. For attachment, the covering strip 15 is pushed on parallel to the row of cooling air outlet openings 14 from the trailing edge 8 in such a way that the holding pins 16, 17, 18 are inserted into the cooling air outlet openings 14 that are provided. In the final inserted position, the covering strip 15 completely covers the cooling air outlet openings 14 with a projection of at most 3 mm on both sides.

Once the covering strip 15 has been plugged on in this way, the coating process can be carried out by means of the already described method. In this case, the covering effect is also assisted by compressed air being introduced via the air inlet openings in the blade root 6, which then emerges from the cooling air outlet openings 14 and via any gaps that may be present between the surface of the blade section 4 and the covering strip 15.

The covering strip 15 is reusable. Since the covering strip 15 as well as the holding pins 16, 17, 18 can be deformed plastically, the covering strip 15 can be matched to different rotor blades 1, within certain limits. After it has been used a certain number of times, the covering strip 15 has the coating that will have been formed on it removed by scraping or blasting.

Instead of applying compressed air to the cavities 9, 10, 11, it is possible for the cooling air outlet openings 14 to be completely covered, forming a seal, by an adhesive tape before the covering strip 15 is plugged on. When the covering strip 15 is being plugged on, the holding pins 16, 17, 18 pierce the adhesive tape, if required through incisions that have previously been provided. In the completely inserted position, the covering strip 15 covers the adhesive tape completely and in this way protects it against excessive heat influences during the coating process.

1.-10. (canceled)

11. A method for producing a turbine component having a flow body and a plurality of cooling air outlet openings arranged in the area of a trailing edge where the flow body is coated by a ceramic spray coating, comprising:
covering the cooling air outlet openings with an adhesive tape before the application of the coating; and
applying a covering strip over the adhesive tape such that the covering strip completely covers the cooling air outlet openings,
wherein the covering strip is a material resistant to the coating process.

12. The method as claimed in claim 11, wherein the covering strip is steel.

13. The method as claimed in claim 12, wherein the covering strip:
has a plurality of projections that fit into the cooling air outlet openings, and
is attached to the blade section by inserting the projections into the cooling air outlet openings.

14. The method as claimed in claim 13, wherein the projections are plastically deformable by a human hand.

15. The method as claimed in claim 14, wherein compressed air is applied to the flow body such that the compressed air flows out of the cooling air outlet openings during the coating process.

16. The method as claimed in claim 15, wherein the adhesive tape is completely covered by the covering strip.

17. The method as claimed in claim 16, wherein the projections pierce the adhesive tape when the covering sheet is inserted.

18. The method as claimed in claim 17, wherein the adhesive tape has incisions corresponding to the locations where the projections are intended to pierce the adhesive tape.

19. The method as claimed in claim 18, wherein any coating material that has penetrated into the cooling air outlet openings is removed by sand blasting.

20. The method as claimed in claim 19, wherein the coating is covered in an area adjacent to the cooling air outlet openings during the sand blasting.
